(19) United States
(12) Patent Application Publication
(10) Pub. No.: US 2011/0281228 A1
(43) Pub. Date: Nov. 17, 2011

(54) POLYCRYSTALLINE CERAMIC ORTHODONTIC COMPONENT

(75) Inventor: Markus Johannes Hirsch, Klagenfurt (AT)

(73) Assignee: PBD, PATENT & BUSINESS DEVELOPMENT AG, Zug (CH)

(21) Appl. No.: 13/138,291

(22) PCT Filed: May 20, 2010
(86) PCT No.: PCT/AT2010/000178

§ 371 Date: Jul. 28, 2011

(30) Foreign Application Priority Data
May 20, 2009 (AT) A 793/2009

(51) Int. Cl. A61C 7/14

(52) U.S. Cl. 433/8

(57) ABSTRACT

The invention relates to a method for producing an orthodontic component (1) formed by a polycrystalline ceramic structure, wherein the powder that is used is formed into a green body and subsequently sintered in a temperature range having a lower limit of more than 1900° C., in particular 2100° C., and an upper limit of 2500° C., in particular 2400° C., preferably 2200° C., over a duration having a lower limit of 3 hours, in particular 5 hours, preferably 7 hours, up to an upper limit of 24 hours, in particular 15 hours, preferably 10 hours. Subsequently, the sintered component (1) is cooled down to room temperature, wherein the material is formed in a thickness of 0.5 mm having inline translucency with a lower limit of 70%, in particular 85%, and an upper limit of 100%.

The invention relates to a method for production of an orthodontic component, such as a bracket, consisting of a polycrystalline ceramic structure, as well as to a component produced according to the method, as described in claims 1 and 13.

A component of an orthodontic appliance comprising a ceramic tooth attachment composed of a polycrystalline, ceramic structure with different additives is known from U.S. Pat. No. 4,954,080 A. This ceramic tooth attachment consists of an aluminum oxide and has a limited translucency in the range of visible light, which reduces the visibility of the tooth attachment, so that the latter, when it is installed on the tooth, practically cannot be seen by an outside third party. This polycrystalline ceramic body for the tooth attachment is produced by means of pressing a highly pure aluminum oxide powder, which is subsequently sintered at temperatures between 1750° C. and 2050° C., in order to have almost zero porosity and an average grain size in the range of 10 to 30 μm. The tooth attachment should preferably be colorless. Translucency in the range of visible light should be 20% to 60% at a sample thickness of 0.5 mm. As a result, deflection or scattering of the incident light occurs within the polycrystalline ceramic body, which lies on the order between 40 and 80%.

EP 0 593 611 B1 describes another orthodontic appliance having a ceramic tooth attachment. The polycrystalline ceramic structure is formed from aluminum oxide, which additionally also contains various additives. The optical permeability for visible light, at a thickness of the sample body of 0.5 mm, lies between 5% and 60%. Furthermore, the ceramic structure additionally has precipitates at the grain boundaries between the polycrystalline grains, which can be seen on X-rays, whereby the precipitates that can be seen on X-rays are formed by admixtures of 3 to 150 ppm ytterbium fluoride. The basic body or the grains that form it can be formed from the aluminum oxide or a highly pure zirconium. Sintering of the green body pre-pressed from the powder, to the desired thickness, can take place under a reduction atmosphere, such as hydrogen, at temperatures between 1750° C. and 1950° C. The time period for sintering can amount to between 45 minutes and several hours, in order to achieve an average grain size between 5 and 40 μm and the desired translucency. In order to reduce the porosity of the basic body, hot isostatic pressing takes place, during which a pressure of about 30,000 psi is applied for a certain time, at a temperature between 1450° C. and 1580° C., in order to lower the pore proportion (V_{P}) in the sintered basic body below 0.003.

When using previous polycrystalline ceramic structures, it was not possible to produce orthodontic components having an inline translucency of more than 60% at a thickness of 0.5 mm.

The present invention is based on the task of indicating a method with which a polycrystalline ceramic orthodontic component, such as a bracket, can be produced, which component has a very high translucency for visible light. Likewise, a component produced according to the method is also supposed to be created.

This task of the invention is accomplished in that the green body is sintered in a temperature range with a lower limit of above 1900° C., particularly 2100° C., and an upper limit of 2500° C., particularly 2400° C., preferably 2200° C., over a time period in a lower limit of 3 hours, particularly 5 hours, preferably 7 hours, up to an upper limit of 24 hours, particularly 15 hours, preferably 10 hours, subsequently the sintered component is cooled to room temperature, whereby the material of the polycrystalline orthodontic component is formed with an inline translucency, at a thickness of 0.5 mm, in a lower limit of 70%, particularly 85%, and an upper limit of 100%.

The advantage that results from the method of procedure according to the characteristics of claim 1 lies in that because of the very high temperatures for the sintering process that are selected, a ceramic orthodontic component can be created that still has a polycrystalline structure, and, despite this polycrystalline structure, visible light is allowed to pass through almost unhindered. This is achieved specifically in connection with the high temperature that acts for a relatively long time. In this connection, a temperature selected to be slightly higher also plays a significant role, because, viewed over the period of time, an enormous amount of energy is introduced into the component to be produced. Thus, a very high degree of translucency is achieved, whereby an almost glass-clear ceramic component having a polycrystalline structure can be created in this way, which component allows looking through it to the tooth surface. These high temperatures in combination with the long period of action bring about an even more intimate and greater binding of the individual grains of the ceramic structure that form the structure, to one another and among one another, thereby making it possible to reduce or actually avoid the irregularities in the structure that occur otherwise. In this way, furthermore, the strength and/or hardness as compared with polycrystalline brackets known until now are also increased. Because of the high degree of translucency achieved in this way, the bracket can adapt itself to the underlying tooth color even better, in interaction with the incident light, and an esthetic advantage for the wearer is achieved. Such brackets can then be recognized optically only with difficulty. Furthermore, there is also the advantage to the effect that because of the great translucency, a great advantage for polycrystalline ceramic components can be achieved also for the fitting process, since in this way, the distribution of the binder between the base surface and the tooth surface can be precisely observed and corrected, if necessary. Furthermore, better inspections of those regions of the tooth that are covered by the orthodontic component in the mounted position of use can also be carried out.

Furthermore, a method of procedure according to the characteristics indicated in claim 2 is advantageous, because in this way, a pre-pressed intermediate state, not yet having the full hardness, can be achieved in this way, during which the processing procedures for final determination of the spatial shape can be carried out before the sintering process, with significantly less effort. In this way, the powder or powder mixture used for forming the polycrystalline ceramic component is pre-compacted only to such an extent that cohesion between the individual grains of the powder is created, but without having to carry out the processing on a very hard component that has been sintered to its final shape.

Another advantageous method of procedure is described in claim 3, by means of which shaping takes place in a first spatial direction and thus in cross-section, and subsequently the further shaping can take place. With this, again, a pre-compacted and not yet sintered object is created, which can be reworked, in terms of its spatial shape, with relatively simple means, and final solidification by means of the sintering process only takes place afterwards.

A method variant according to claim 4 is also advantageous, because in this way, even greater pre-compacting between the individual grains of the power or powder mixture takes place, in the form of a partial melting process. In this way, slightly higher strengths for the finishing process are achieved, whereby the fully hardened ceramic component does not yet have to be processed in this process.

Furthermore, a method of procedure according to the characteristics indicated in claim 5 is advantageous, because in this way, faster and better adhesion between the individual grains, relative to one another, can be achieved.

Another advantageous variant is described in claim 6, which makes it possible to make do with simple and cost-advantageous processing methods, since the component, which is not yet sintered, has a significantly lower hardness and thus the tool wear can be kept low.

A method variant according to claim 7 is also advantageous, because in this way, in combination with the high sintering temperatures, a polycrystalline ceramic structure can be achieved, which has the desired high translucency.

Furthermore, a method according to the characteristics indicated in claim 8 is advantageous, because in this way, it is now possible to produce a tooth attachment that consists of polycrystalline grains, in which attachment precipitates visible on X-rays can simultaneously be produced during the course of the sintering process. In this way, a long useful lifetime at great strength is also achieved. The essential thing is that the translucency in the range of visible light is not detrimentally influenced by the embedding, at the grain boundaries, of precipitates that are visible on X-rays. It is now a particular advantage of this embodiment that in the event of accidental swallowing of such a tooth attachment or part of this tooth attachment, it can now be seen on an X-ray image, and thus can be localized in the human body at any time. As a result, the ceramic parts, which generally have sharp edges, or fragments of these parts, can be found in simple manner, and in this way internal injuries can be reduced or avoided entirely.

Other advantageous methods of procedure are described in claim 9 or 10, by means of which the properties of the ceramic component can be additionally improved. Because of the use of the yttrium or lanthanum oxide, the strength of the component can be increased. At the same time, however, the processing temperature can be reduced within certain limits, as a result of which an even better homogeneous structure can be achieved at these high temperatures.

Furthermore, a method of procedure according to the characteristics indicated in claim 11 or 12 is advantageous, because in this way, an overall greater strength of the component can be achieved. At the same time, however, overly rapid grain growth can be prevented in this way.

However, the task of the invention is also accomplished, in connection with the method, by means of the characteristics of claim 13. The advantages that result from the combination of characteristics of the claim lie in that in this way, in combination with the production method, an almost transparent or transparent polycrystalline component can be created, which allows looking through it all the way to the tooth surface in its mounted position, and thus the esthetic appearance is improved during the treatment period.

Another embodiment according to claim 14 is also advantageous, because in this way, in connection with the high sintering temperatures, a polycrystalline ceramic structure that has the desired high translucency can be achieved.

Finally, however, an embodiment as described in claim 15 is also possible, for producing a tooth attachment that consists of polycrystalline grains, during which precipitates that are visible on X-rays can be produced at the same time, in the course of the sintering process. In this way, a long useful lifetime at great strength is also achieved. The essential thing is that the translucency in the range of visible light is not detrimentally influenced by the embedding, at the grain boundaries, of precipitates that are visible on X-rays. It is now a particular advantage of this embodiment that in the event of accidental swallowing of such a tooth attachment or part of this tooth attachment, it can now be seen on an X-ray image, and thus can be localized in the human body at any time. As a result, the ceramic parts, which generally have sharp edges, or fragments of these parts, can be found in simple manner, and in this way internal injuries can be reduced or avoided entirely.

For a better understanding of the invention, it will be explained in greater detail, using the following figures.

These show, in a greatly simplified, schematic representation, in each instance:

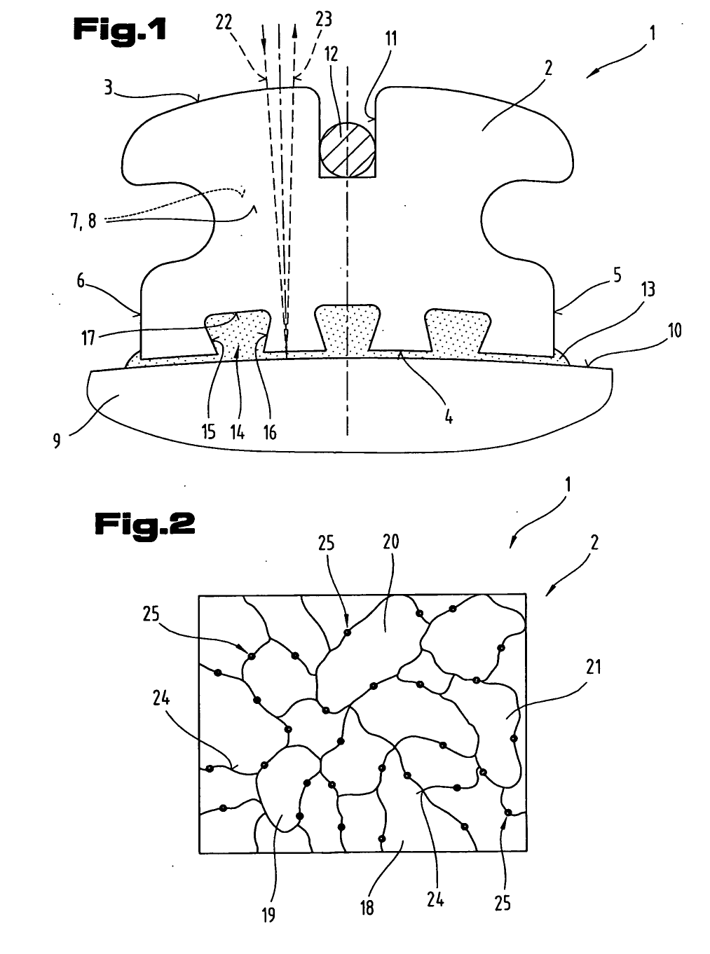

FIG. 1 an orthodontic component in an elevation;

FIG. 2 a part of the orthodontic component in extremely great magnification, with the grains that form the crystalline structure.

As an introduction, it should be stated that in the various embodiments described, the same parts are provided with the same reference symbols or component designations, whereby the disclosures contained in the entire specification can be applied analogously to the same parts that have the same reference symbol or the same component designation. Also, the position indications stated in the specification, such as top, bottom, side, etc. make reference to the figure directly described or represented, and must be applied analogously to the new position if the position is changed. Furthermore, individual characteristics or combinations of characteristics from the different exemplary embodiments shown and described can also represent independent inventive solutions or solutions according to the invention.

All the information concerning value ranges in the present specification must be understood to mean that these cover any and all partial ranges within them, for example the statement 1 to 10 should be understood to mean that all the partial ranges, starting from the lower limit 1 and including the upper limit 10, i.e. all partial ranges start with a lower limit of 1 or greater and end with an upper limit of 10 or less, for example 1 to 1.7 or 3.2 to 8.1 or 5.5 to 10.

In FIGS. 1 and 2, a possible embodiment of an orthodontic component 1 is shown in simplified form, whereby it should be mentioned that the outline shapes shown in FIG. 1, or the geometry, of component 1 are shown only as an example, and that these are dependent on the purpose of use or the location of use and must be adapted to that.

The orthodontic component 1 is used in dentistry and is usually referred to as a so-called “bracket” there, and serves, among other things, for correcting incorrect tooth positions.

The orthodontic component 1 comprises a basic body 2 that is delimited in its spatial shape, in simplified form, by a visible surface 3 that faces the viewer, a base surface 4 that faces away from the former, and side surfaces 5 to 8 that extend between them. The base surface 4 serves for affixing the basic body 2 to a tooth 9 having a tooth surface 10, shown in simplified manner. Furthermore, in the area of the visible surface 3, an accommodation slit 11 for accommodating a brace wire 12 is also shown. Here, the accommodation slit 11 extends from the visible surface 3 in the direction to the base surface 4 and between the two side surfaces 7, 8.

The base surface 4 serves for being affixed to the tooth surface 10 of the tooth 9 by way of a holding means 13, for example an adhesive or the like, and thus being connected with the tooth 9. The holding means 13 is represented in simplified manner, by means of dots. To increase the size of the connecting surface on the basic body 2, at least one, but preferably multiple groove-shaped recesses 14 can be disposed in the basic body 2, recessed into the base surface 4, which extend in the direction of the visible surface 3, proceeding from the base surface 4. Here, the longitudinal expanse of the groove-shaped recess 14 runs between the two side surfaces 7 and 8.

Here, the recess 14 has an approximately swallowtail-shaped cross-section, seen in an axial section. This cross-sectional shape is delimited by side walls 15, 16 that run toward one another in trapezoid shape or conically, in the direction toward the base surface 4, as well as by a groove root 17. Slightly rounded-off or rounded-out areas can be provided between the two side walls 15 and 16, as well as the groove root 17 and the base surface 4, respectively, in order to avoid a sharp-edged transition.

The orthodontic component 1 is formed from a polycrystalline ceramic structure, the basic body 2 of which is formed from a plurality of grains 18 to 21, as can best be seen in FIG. 2.

These grains 18 to 21 for forming the polycrystalline ceramic component 1 are present in powder form, at first, whereby admixtures of a binder and/or of additive materials can be mixed into this powder, if necessary. The powder or powder mixture intended for forming the ceramic component 1 is formed into a so-called green body, with the application of pressure and/or temperature action, whereby this can be done in a pressing process, an extrusion process, or in the form of an “injection-molding process.” In other words, a “green body” is understood to be a pre-solidified body of the powder or powder mixture, which is subsequently converted into the polycrystalline ceramic component 1 in a sintering process.

It is advantageous, in this connection, that the powder or powder mixture for forming the polycrystalline component 1 is first only pre-shaped, and that in this pre-shaped form, simple finishing of the rough shapes, all the way to the desired component 1, can actually take place before the subsequent sintering process. Thus, processing of the green body can still take place with little effort, whereby a corresponding coordination of dimensions of the green body must take place for the subsequent sintering process, in order to ensure the dimensional accuracy of the finished, sintered component 1. The shaping process of the green body can take place in a pressing process, by means of applying pressure. Likewise, however, it would also be possible to form a rod-shaped object from the powder or powder mixture in an extrusion process, and to subsequently cut the individual basic bodies to length from this rod-shaped object, and thus, again, to form separate individual parts intended for the subsequent sintering process. Green bodies produced during the course of the extrusion process as well as the subsequent cutting process can also subsequently be processed in simple manner, in a relatively soft state.

The green body produced in this manner is then sintered in a temperature range having a lower limit of above 1900° C., particularly 2100° C., and an upper limit of 2500° C., particularly 2400° C., preferably 2200° C. Good translucency values on the order of between 70% and approximately 80%, in some cases even slightly higher (83% to 84%), were already achieved at a sintering temperature of slightly above 1900° C. The duration of the sintering process at the temperatures indicated above should be carried out over a time span in a lower limit of 3 hours, particularly 5 hours, preferably 7 hours, up to an upper limit of 24 hours, particularly 15 hours, preferably 10 hours. Subsequent to the sintering process, cooling of the sintered component 1 to room temperature takes place, whereby because of the very high sintering temperature that was selected, a ceramic component 1 having a polycrystalline structure is obtained, which has an inline translucency, at a thickness of the sample body of 0.5 mm, in a lower limit of above 70%, preferably 80%, particularly 85%, and an upper limit of 100%. The grain size of the individual grains that are sintered together to form the ceramic structure can lie in a lower limit of 10 μm and an upper limit of 60 μm.

The higher the degree of translucency becomes, the more crystal-clear the polycrystalline ceramic component 1 looks. As a result, the proportion of visible light that can pass unhindered through the entire basic body 2, all the way to the tooth 9 or the tooth surface 10, is also increased, as is shown in simplified manner by an incident beam 22 as well as a reflection beam 23 reflected by the tooth surface 10, in FIG. 1.

Because of this high degree of translucency, deflection or scattering at least of the visible'light within the basic body 2 is greatly reduced or actually avoided entirely, resulting in an optically glass-clear component 1 at a very high degree of translucency.

For pre-solidification of the green body before the sintering process, it can prove to be advantageous if the body is pre-treated over a time period in a lower limit of 1 hour and an upper limit of 24 hours, at a temperature in a lower limit of 600° C. and an upper limit of 1400° C., particularly pre-fired. Here, a time period of approximately 2 hours at a temperature around 1000° C. has proven to be advantageous. This pre-firing process serves for pre-solidification of the green body and can be carried out with the feed of air enriched with oxygen, if necessary. This pre-solidification can take place before and/or after the processing method for better determination of the spatial shape of the component 1. Thus, it is possible to still work on the green body or the green body that has already been pre-fired, before the sintering process that takes place, within the course of its further shaping, in simple manner, in terms of its external spatial shape.

The basic body 2 or the component 1 can be selected from at least one of the materials from the group of aluminum oxide (Al₂O₃), highly pure zirconium. Furthermore, it is also possible that ytterbium fluoride is mixed into the power for forming the polycrystalline ceramic component 1, whereby this can take place in an amount having a lower limit of 3 ppm and an upper limit of 150 ppm.

Likewise, however, it is also possible to mix highly pure yttrium oxide into the powder for forming the polycrystalline ceramic component 1, whereby this can take place in an amount in a lower limit of 60 ppm and an upper limit of 120 ppm. However, it would also be possible to mix highly pure lanthanum oxide into the power for forming the polycrystalline ceramic component 1, whereby this can take place in an amount in a lower limit of 3 ppm and an upper limit of 30 ppm.

To improve the degree of translucency, magnesium oxide in an amount of less than 0.1 wt.-% can also be mixed into the powder for forming the polycrystalline ceramic component 1. Independent of this, however, magnesium fluoride in an amount having a lower limit of 0.01 wt.-% and an upper limit of 0.5 wt.-% can also be mixed into the powder. All of the further materials described above are also present in powder form and can be mixed into the basic material, in powder form, in the amounts indicated above.

In FIG. 2, the microstructure of the structure of the basic body 2, composed of the polycrystalline ceramic material, is shown in a greatly magnified representation. The ceramic material, which has already been sintered, is formed or composed of a plurality of grains 18 to 21, whereby additional precipitates 25, which differ from the grains 18 to 21 by their visibility under X-rays, form at grain boundaries 24. In this way, it is now possible to be able to locate a piece of the tooth attachment that forms the component 1, in the body of a patient, using X-rays, for example if it gets into the body of a wearer of such an orthodontic appliance unintentionally.

The precipitates described above, which are visible on an X-ray, can be formed from admixtures of at least one of the additives described, particularly ytterbium fluoride. By adding yttrium oxide and/or lanthanum oxide, for example, the strength of the component 1 can be additionally increased.

Translucency is understood to mean partial light permeability of a body. Thus, there are many substances that are translucent, because they permit light to pass through, but are not transparent. As a distinction from transparency, translucency can be described as allowing light to pass through, and transparency as allowing an image or view to pass through. The higher the values for translucency are selected to be, the closer translucency approaches transparency. Transparency is the effect of transmission, whereby here, in physics, this is understood to be the capacity of matter to allow electromagnetic waves to pass through. If the waves—particularly visible light—do not succeed in penetrating matter, then the electrons of the medium absorb energy from the light wave and the waves are absorbed on their path through it. The material is therefore non-transparent. However, if the waves succeed in passing through the material or the substance, then there is an interaction between the light and the atoms, and the waves cannot give off any energy to the atoms. The material is therefore transparent. Transparency is therefore not only a property of the material, but also refers to the electromagnetic wavelength being considered. Transparency is thus an optical property of a substance or material. In general, a material or substance is referred to as transparent or transparent if one can recognize what lies behind it relatively clearly. Complete transparency can also be referred to as glass-clear.

In order to reduce the visibility of the orthodontic component 1 during its intended use on a tooth 9 of a patient, it is advantageous if the material for forming the basic body 2, particularly if this is selected from a polycrystalline structure, has an inline translucency having a lower limit of above 70%, particularly 85%, and an upper limit of 100%, at a thickness of 0.5 mm. In this way, the result is achieved that beams of light that enter the orthodontic component 1 can penetrate all the way to the tooth surface 10 and are reflected by it. Then, a reflection beam 23 that corresponds to the color of the tooth exits from the component 1. Because only a slight proportion of the light beams that enter into the component 1 (incident beam 23) does not exit from it again, the optical impression is given that the orthodontic component 1 takes on the tooth coloring of the tooth inherent to each user. Thus, an orthodontic component 1 has been created, in simple manner, that is simple in production, on the one hand, and, on the other hand, represents an optical inconspicuousness for the user.

If the composition of the material of component 1 is changed accordingly, the exit of reflected beams can be reduced or prevented. In this way, the inherent coloring of the component 1 is placed into the foreground, and clear optical visibility as compared with the tooth occurs.

The degree of transmission of radiation through a material is defined by the degree of translucency, which is the ratio of the intensity of the transmitted beam and the intensity of the incident beam, and is put into relation with the radiation at a specific wavelength and a sample having a specific thickness.

These variables are put into relation with one another by the following formula

I/I₀=ke^{-ad}

in which
“I/I₀” are the intensities of the transmitted beam and of the incident beam;
“d” is the thickness of the sample;
“a” is the absorption coefficient and
“k” is a constant that can be determined from the index of refraction of the material.

In this connection, the cone angle of the incident beam and the cone angle of the transmitted beam must also be indicated.

Measurement of the degree of transmission can be carried out, for example, using a laser beam at a wavelength of 0.63 mm, so that the cone angle of the incident beam lies very close to zero. The cone angle of the transmitted beam, which is used for determining the intensity of the transmitted beam, can amount to 60°, for example. In this manner, a degree of transmission, in other words an inline translucency, can be defined.

In this way, it is possible to determine the inline translucency using a Perkin-Elmer lambda spectrometer, for example Type 9UV/VIS/NIR, where the wavelength range can amount to between 400 nm and 800 nm, for example.

Preferably, the thickness of the test body is 0.5±0.005 mm, whereby high-quality surface processing must be provided, in other words highly fine polishing must take place, in order to avoid reflection of the light due to irregularities in the surface of the test body, which can significantly impair the measurement result. Fundamentally, it must be taken into consideration that the measurement of inline translucency represents a difficult problem for the reason that the amount of the light radiated onto a test body is put into relation with the amount of that light of a given wavelength that exits from the test body. The difference in these two light amounts lies in the fact that the incident light is deflected and therefore scattered as the result of irregularities in the sample, such as grains, grain boundaries, and the like. This deflection and scattering depends significantly on the size and shape of the irregularities, and a measurement of the division of the light becomes difficult if their size gets into the range of the wavelength that was used for this measurement experiment. For this reason, each test sample must be produced with two surfaces that are plan-parallel to one another, and must be polished to a pre-defined surface roughness.

For measuring the inline translucency, the sample body is illuminated with a directed or parallel-bundled light beam having low divergence, which is directed perpendicular to the surface of the test body. A partial loss in the radiation intensity is brought about by the transition of the radiation from air to the test body, due to the different index of refraction between air and the test body. The light intensity that enters into the test body is then deflected in different directions by irregularities. For this reason, the permitted incidence angle of the radiation with reference to the measurement device is a significant factor for determining the inline translucency. The greater the permitted incidence angle, the greater the measured inline translucency for the same test body.

For this reason, for all samples, both the incidence angle of the light beam impacting on the test body and the light exit angle of the exiting light beam should be kept the same.

Preferably, for example, an angle of 3° can be accepted as an entry angle. In this connection, it is advantageous to use a beam directed at the test body, having a width of 0.2 mm and a height of 0.5 mm, and to provide an aperture having a diameter of 1 mm or 0.5 mm.

However, it is also possible to set the incidence angle of the transmitted beam at about 60°.

Now, it is essential that color assumption of the bracket corresponding to the color of the underlying tooth is optically achieved when the translucency is very high, for example above 70%, particularly 85%, up to 100%, because in this way, a large portion of the light radiated in impacts the tooth in a perpendicular direction, and is reflected outward by the tooth, so that for an observer, essentially only the color of the tooth can be recognized, and the orthodontic component 1 or the bracket appears to assume the color of the tooth.

If a component 1 configured to be completely glass-clear or transparent is used, this also has the further advantage that during the mounting process of the component 1 on the tooth surface 10 of the tooth 9, the technician has an unhindered view through the component all the way to the tooth surface 10. As a result, distribution of the connection agent in the recesses 14 described above, in the region of the base surface 4, can be better controlled. In addition, however, it is also significantly easier for a curing process of the connection agent, if the latter is passed through UV light or similar electromagnetic waves, that the waves or the radiation can pass through the material of the component 1. In this way, uniform curing and thus a better adhesion result can be achieved over the entire connection surface of the support body or basic body 2 with the tooth 9.

The exemplary embodiments describe possible embodiment variants of the polycrystalline component 1, whereby it should be noted at this point that the invention is not restricted to the embodiment variants specifically represented, but rather, diverse combinations of the individual embodiment variants with one another are possible, and this variation possibility lies within the ability of a person skilled in this art, on the basis of the teaching for technical action by means of the present invention. Also, possible embodiment variants that result from combining individual details of the embodiment variant shown and described are covered.

For the sake of good order, it should be pointed out, in conclusion, that for a better understanding of the structure of the orthodontic component 1 or its parts, these have been shown not true to scale and/or enlarged and/or reduced in size, in part.

The task on which the independent inventive solutions are based can be derived from the specification.

### REFERENCE SYMBOL LIST

1 component
2 basic body
3 visible surface
4 base surface
5 side surface
6 side surface
7 side surface
8 side surface
9 tooth
10 tooth surface
11 accommodation slot
12 brace wire
13 holding means
14 recess
15 side wall
16 side wall
17 groove root
18 grain
19 grain
20 grain
21 grain
22 incident beam
23 reflection beam
24 grain boundary
25 precipitate

1. Method for production of an orthodontic component (1), such as a bracket, consisting of a polycrystalline ceramic structure, in which the powder used for forming the polycrystalline ceramic component (1), if necessary with admixture of a binder as well as additive materials, is shaped into a green body and subsequently the green body is sintered, wherein the green body is sintered in a temperature range with a lower limit of above 1900° C., particularly 2100° C., and an upper limit of 2500° C., particularly 2400° C., preferably 2200° C., over a time period in a lower limit of 3 hours, particularly 5 hours, preferably 7 hours, up to an upper limit of 24 hours, particularly 15 hours, preferably 10 hours, subsequently the sintered component (1) is cooled to room temperature, wherein the material of the polycrystalline orthodontic component (1) is formed with an inline translucency, at a thickness of 0.5 mm, in a lower limit of 70%, particularly 85%, and an upper limit of 100%.

2. Method according to claim 1, wherein the powder for forming the polycrystalline ceramic component (1) is shaped into a green body by applying pressure, by means of a pressing process.

3. Method according to claim 1, wherein the powder for forming the polycrystalline ceramic component (1) is shaped to form a rod-shaped object, in an extrusion process, and subsequently the individual green bodies are cut off the rod-shaped object.

4. Method according to claim 1, wherein the green body is pre-fired, before the sintering process, over a time period in a lower limit of 1 hour, particularly 2 hours, and an upper limit of 24 hours, particularly at a temperature in a lower limit of 600° C. and an upper limit of 1400° C.

5. Method according to claim 4, wherein the pre-firing process of the green body is carried out with the addition of air enriched with oxygen.

6. Method according to claim 1, wherein the green body or the pre-fired green body is processed in terms of its spatial shape, for further shaping, before the sintering process.

7. Method according to claim 1, wherein the polycrystalline orthodontic component (1) is formed from at least one of the materials from the group of aluminum oxide (Al₂O₃), highly pure zirconium.

8. Method according to claim 1,
wherein ytterbium fluoride is mixed into the powder for forming the polycrystalline ceramic component (1), in an amount having a lower limit of 3 ppm and an upper limit of 150 ppm.

9. Method according to claim 1, wherein highly pure yttrium oxide is mixed into the powder for forming the polycrystalline ceramic component (1), in an amount having a lower limit of 60 ppm and an upper limit of 120 ppm.

10. Method according to claim 1, wherein highly pure lanthanum oxide is mixed into the powder for forming the polycrystalline ceramic component (1), in an amount having a lower limit of 3 ppm and an upper limit of 30 ppm.

11. Method according to claim 1, wherein magnesium oxide is mixed into the powder for forming the polycrystalline ceramic component (1), in an amount of less than 0.1 wt.-%.

12. Method according to claim 1, wherein magnesium fluoride is mixed into the powder for forming the polycrystalline ceramic component (1), in an amount having a lower limit of 0.01 wt.-% and an upper limit of 0.5 wt.-%.

13. Orthodontic component (1), such as a bracket, consisting of a polycrystalline ceramic structure, if necessary with admixture of a binder as well as additive materials, produced according to a method according to claim 1, wherein the material of the polycrystalline orthodontic component (1) has an inline translucency, at a thickness of 0.5 mm, in a lower limit of 70%, particularly 85%, and an upper limit of 100%.

14. Orthodontic component (1) according to claim 13, wherein it is formed from at least one of the materials from the group of aluminum oxide (Al₂O₃), highly pure zirconium.

15. Orthodontic component (1) according to claim 13, wherein the precipitates (25) that are visible in X-ray light are disposed at the grain boundaries (24) between the polycrystalline grains (18-21), whereby these precipitates are formed by admixtures of ytterbium fluoride in an amount having a lower limit of 3 ppm and an upper limit of 150 ppm.
